(19) United States
(12) Patent Application Publication
(10) Pub. No.: US 2019/0209877 A1
(43) Pub. Date: Jul. 11, 2019

(54) RETRACTABLE LIFELINE ASSEMBLY

(71) Applicant: Pure Safety Group, Inc., Pasadena, TX (US)

(72) Inventor: William Leo Farrell, Kent, WA (US)

(73) Assignee: Pure Safety Group, Inc., Pasadena, TX (US)

(21) Appl. No.: 16/230,910

(22) Filed: Dec. 21, 2018

Related U.S. Application Data
(60) Provisional application No. 62/659,823, filed on Apr. 19, 2018.
(60) Provisional application No. 62/614,752, filed on Jan. 8, 2018.

(51) Int. Cl. A62B 35/00; F16D 63/00; E04G 21/32; B65H 59/10

(52) U.S. Cl. CPC A62B 35/0056; B65H 59/10; E04G 21/3204; F16D 63/006

(57) ABSTRACT

A retractable lifeline assembly includes a housing including a sidewall, a rotatable member inside the housing, a first engaging mechanism coupled to the rotatable member, and a crank including a crank handle and a second engaging mechanism. The crank is pivotally coupled to the sidewall such that the crank is selectively movable between a first crank position, in which the second engaging mechanism is engaged with the first engaging mechanism, and a second crank position, in which the second engaging mechanism is disengaged from the first engaging mechanism. The crank handle selectively engages the first engaging mechanism when the crank is in the first crank position to rotate the rotatable member.

### CROSS-REFERENCE TO RELATED APPLICATIONS

This application claims the benefit of U.S. Provisional Application Ser. No. 62/614,752, filed Jan. 8, 2018, and U.S. Provisional Application Ser. No. 62/659,823, filed Apr. 19, 2018, which are incorporated in their entirety herein by reference.

### BACKGROUND

Known safety equipment is used to reduce a likelihood of a fall and/or injuries associated with a fall, particularly at relatively dangerous heights. Some safety equipment may include, for example, a lifeline that is connectable to an anchor point. Such lifelines may extend between the anchor point and a user (e.g., a user connected to a horizontal lifeline via a lanyard and a harness), allowing the user to move while remaining tethered to the anchor point. Adjusting the lifeline for at least some known safety equipment, however, may be tedious, time-consuming, and/or cumbersome (e.g., tensioning the lifeline of a horizontal lifeline assembly).

For the reasons stated above and for other reasons stated below, which will become apparent to those skilled in the art upon reading and understanding the present specification, a need exists for the present invention.

### SUMMARY

The above-mentioned problems associated with prior devices are addressed by embodiments of the disclosure and will be understood by reading and understanding the present specification. The following summary is made by way of example and not by way of limitation.

Examples of the disclosure enable a lifeline to be adjusted in a quick, efficient, and user-friendly manner. In one aspect, a retractable lifeline assembly is provided. The retractable lifeline assembly includes a housing including a sidewall, a rotatable member inside the housing, a first engaging mechanism coupled to the rotatable member, and a crank including a crank handle and a second engaging mechanism. The crank is pivotally coupled to the sidewall such that the crank is selectively movable between a first crank position, in which the second engaging mechanism is engaged with the first engaging mechanism, and a second crank position, in which the second engaging mechanism is disengaged from the first engaging mechanism. The crank handle is selectively engages the first engaging mechanism when the crank is in the first crank position to rotate the rotatable member.

In another aspect, the retractable lifeline assembly includes a housing, a rotatable member inside the housing, a housing handle coupled to the housing, and a release mechanism between the housing handle and the housing. The release mechanism is selectively actuatable to move the retractable lifeline assembly between an unlocked configuration, in which the rotatable member is allowed to rotate in a plurality of directions, and a locked configuration, in which the rotatable member is restricted from rotating in at least one direction of the plurality of directions.

In yet another aspect, a method is provided for manufacturing a retractable lifeline assembly. The method includes positioning a rotatable member inside a housing that includes a sidewall, coupling a first engaging mechanism to the rotatable member, and hingedly coupling a crank to the sidewall such that the crank is selectively movable between an engaged position and a disengaged position. The crank includes a second engaging mechanism that is engaged with the first engaging mechanism when the crank is in the engaged position and disengaged from the first engaging mechanism when the crank is in the disengaged position. The crank further includes a crank handle that is selectively revolvable about the first engaging mechanism when the crank is in the engaged position to rotate the rotatable member.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a plan view of an example retractable lifeline assembly.

FIG. 2 is a perspective view of the retractable lifeline assembly shown in FIG. 1 in an engaged configuration.

FIG. 3 is a perspective view of the retractable lifeline assembly shown in FIG. 1 in a disengaged configuration.

FIG. 4 is a flowchart of an example method of manufacturing a retractable lifeline assembly, such as the retractable lifeline assembly shown in FIG. 1.

FIG. 5 is a perspective view of a plurality of example components that may be used in another example retractable lifeline assembly, with a portion of a housing removed.

FIG. 6 is a perspective view of a portion of the retractable lifeline assembly shown in FIG. 5.

FIG. 7 are plan views of a portion of the retractable lifeline assembly shown in FIG. 5 in an engaged position.

FIG. 8 are plan views of a portion of the retractable lifeline assembly shown in FIG. 5 in a disengaged position.

FIG. 9 is an exploded view of an example release mechanism that may be used in a retractable lifeline assembly, such as the retractable lifeline assembly shown in FIG. 5.

FIG. 10 is a perspective view of the release mechanism shown in FIG. 9.

FIG. 11A is a front perspective view of an example pawl that may be used in a retractable lifeline assembly, such as the retractable lifeline assembly shown in FIG. 5.

FIG. 11B is a rear perspective view of the pawl shown in FIG. 11A.

FIG. 12 is a perspective view of an example connecting member that may be used in a retractable lifeline assembly, such as the retractable lifeline assembly shown in FIG. 5.

FIG. 13A is a front perspective view of an example handle that may be used in a retractable lifeline assembly, such as the retractable lifeline assembly shown in FIG. 5.

FIG. 13B is a rear perspective view of the handle shown in FIG. 13A.

FIG. 14 is an exploded perspective view of an example retractable lifeline assembly.

FIG. 15 is a perspective view of a portion of the retractable lifeline assembly shown in FIG. 14.

FIG. 16 is a bottom view of the portion of the retractable lifeline assembly shown in FIG. 15.

FIG. 17 is an exploded perspective view of an engaging mechanism of the retractable lifeline assembly shown in FIG. 14.

FIG. 18 is an exploded perspective view of another embodiment engaging mechanism for use with the retractable lifeline assembly shown in FIG. 14.

Corresponding reference characters indicate corresponding parts throughout the drawings. Although specific features may be shown in some of the drawings and not in others, this is for convenience only. In accordance with the examples described herein, any feature of a drawing may be referenced and/or claimed in combination with any feature of any other drawing.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

When introducing elements of the disclosure or the examples thereof, the articles “a,” “an,” “the,” and “said” are intended to mean that there are one or more of the elements. References to an “embodiment” or an “example” of the present disclosure are not intended to be interpreted as excluding the existence of additional embodiments or examples that also incorporate the recited features. The terms “comprising,” “including,” and “having” are intended to be inclusive and mean that there may be elements other than the listed elements. The phrase “one or more of the following: A, B, and C” means “at least one of A and/or at least one of B and/or at least one of C.”

It is to be understood that other embodiments may be utilized and mechanical changes may be made without departing from the spirit and scope of the present disclosure. The following detailed description is, therefore, not to be taken in a limiting sense.

Example embodiments of the disclosure relate to safety equipment and, more particularly, to a retractable lifeline assembly such as a horizontal lifeline assembly. Examples described herein include a crank that is pivotally or hingedly coupled to a housing. The crank is securely coupled to the housing while being selectively movable between an engaged position and a disengaged position. In the engaged position, the crank may be used to rotate a rotatable member inside the housing.

Moreover, the examples described herein include a release mechanism that is selectively actuatable to move the retractable lifeline assembly between an unlocked configuration and a locked configuration. The release mechanism may be positioned between the housing and a housing handle. The release mechanism includes a grip portion that allows a user to easily access the release mechanism while using the housing handle. In this manner, the examples described herein enable a user to quickly and/or easily adjust (e.g., extend or retract) a lifeline extending around the rotatable member. Additionally, the examples described herein enable the user to quickly and/or easily move the retractable lifeline assembly between operating configurations.

In at least some examples, the retractable lifeline assembly includes a first engaging mechanism coupled to the rotatable member and a second engaging mechanism at the crank. The second engaging mechanism is engaged with the first engaging mechanism when the crank is in the engaged position and disengaged from the first engaging mechanism when the crank is in the disengaged position. While the examples are described in the context of safety equipment, one of ordinary skill in the art would understand and appreciate that the examples described herein may be used for various purposes in a wide range of contexts or situations, including both safe and precarious situations, in which a user rotates a rotatable member and/or adjusts an operating configuration.

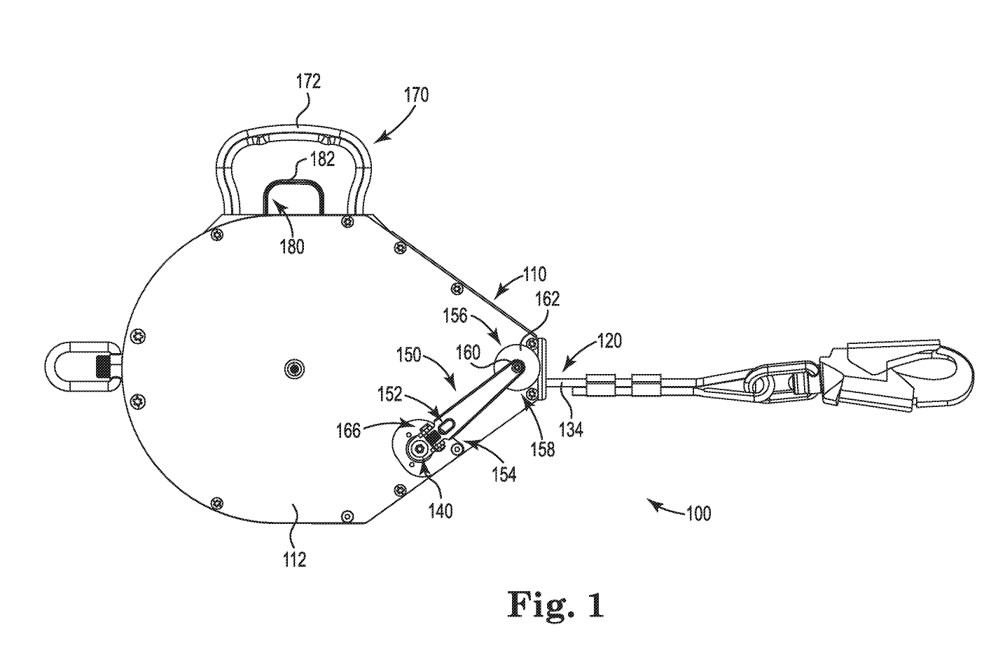

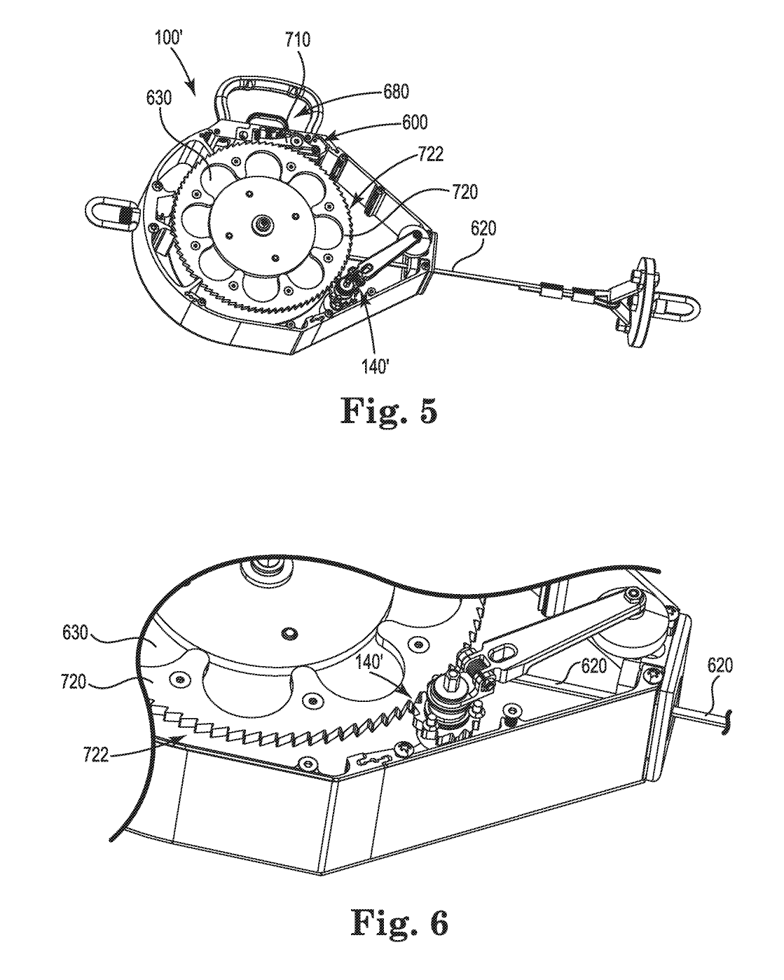

FIGS. 1-3 show an example retractable lifeline assembly 100 including a housing 110. The housing 110 includes one or more sidewalls 112 that are spaced to form a cavity therebetween. The sidewalls 112 may be spaced, for example, to house one or more components, such as a lifeline 120. The lifeline 120 is extendable about (retracted) and/or from (extended or paid out) a rotatable member (shown as 630 in FIGS. 5-8) in the housing 110. The lifeline 120 may have, for example, a first segment (not shown) extending about the rotatable member (not shown) inside the housing 110 (e.g., an inner segment), and a second segment 134 extending from the rotatable member outside the housing 110 (e.g., an outer segment). In some examples, the lifeline 120 extends through an opening defined by and/or through one or more sidewalls 112. Example lifelines 120 include, without limitation, a cable, a wire, a cord, a webbing, and/or a rope.

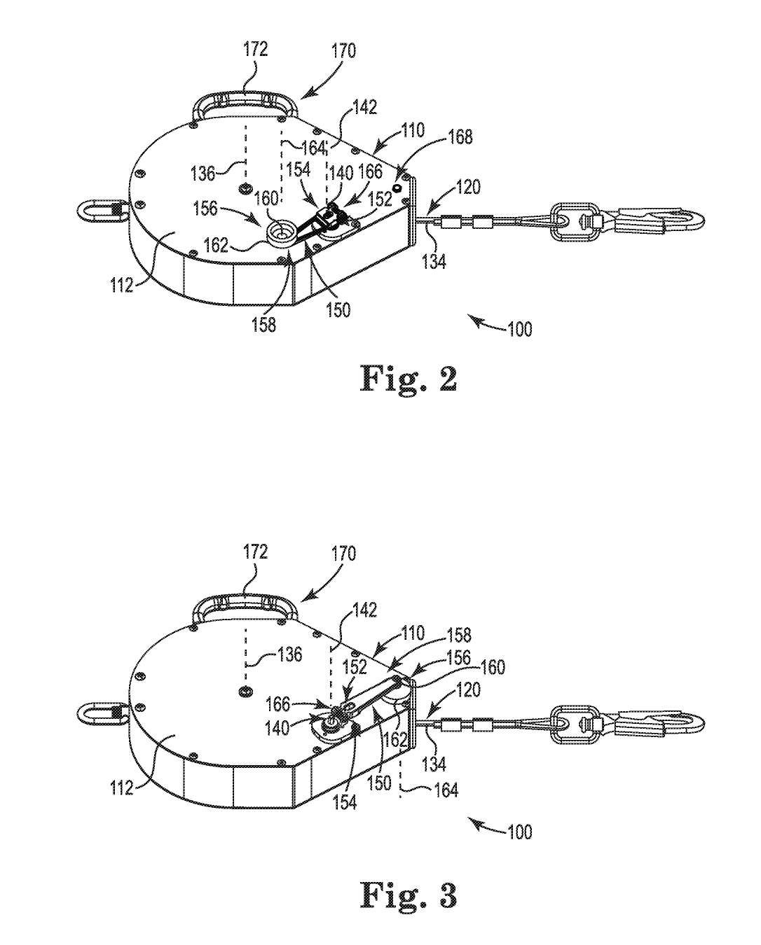

A proportion of the lifeline 120 in the first segment and/or in the second segment 134 may change as the rotatable member is rotated about its axis of rotation 136 (shown in FIGS. 2 and 3). For example, a proportion of the lifeline 120 in the first segment may increase and/or a proportion of the lifeline 120 in the second segment 134 may decrease when the rotatable member rotates in a first direction (e.g., a clockwise direction). For another example, a proportion of the lifeline 120 in the first segment may decrease and/or a proportion of the lifeline 120 in the second segment 134 may increase when the rotatable member rotates in a second direction (e.g., a counterclockwise direction).

The retractable lifeline assembly 100 includes a first engaging mechanism 140 that may be used to rotate the rotatable member. The first engaging mechanism 140 may include a shaft or shank that is sized, shaped, and/or configured to be held in a clamp or chuck. A drill or driver including a clamp or chuck, for example, may be used to rotate the engaging mechanism 140. In some examples, the first engaging mechanism 140 extends outward from and generally perpendicular to an outer surface of a sidewall 112. Example first engaging mechanisms 140 include, without limitation, a round shank, a triangle shank, a square shank, and/or a hex shank. Additionally or alternatively, the first engaging mechanism 140 may include one or more walls defining an opening sized to receive a shaft or shank.

The first engaging mechanism 140 is coupled to the rotatable member such that the rotatable member rotates about the first axis of rotation 136 as the first engaging mechanism 140 is rotated about its axis of rotation 142 (shown in FIGS. 2 and 3), and/or such that the first engaging mechanism 140 rotates about the second axis of rotation 142 as the rotatable member is rotated about the first axis of rotation 136. In some examples, the first engaging mechanism 140 is coupled to the rotatable member using a gear train configured to create a mechanical advantage (e.g., for rotating the rotatable member). In this manner, the first engaging mechanism 140 allows the lifeline 120 to be efficiently wound around and/or unwound from the rotatable member.

The retractable lifeline assembly 100 includes a crank 150 that may be used to rotate the first engaging mechanism 140. The crank 150 includes a second engaging mechanism 152 that is configured to selectively cooperate with and/or engage the first engaging mechanism 140. The second engaging mechanism 152 may include one or more walls defining an opening sized to selectively receive the first engaging mechanism 140. Additionally or alternatively, the second engaging mechanism 152 may include a shaft or shank operatively connected to the first engaging mechanism selectively received within the opening.

The second engaging mechanism 152 may be positioned to engage the first engaging mechanism 140 such that the first engaging mechanism 140 rotates as the second engaging mechanism 152 is rotated. In some examples, the crank 150 acts as a lever that is pivotable about the second engaging mechanism 152 to create a mechanical advantage (e.g., for rotating the first engaging mechanism 140). The crank 150 may include, for example, the second engaging mechanism 152 at a first end portion 154 (e.g., a proximal end portion) and a crank handle 156 at a second end portion 158 (e.g., a distal end portion). In this manner, the crank 150 allows the first engaging mechanism 140 to be efficiently rotated (e.g., for winding the lifeline 120 around and/or unwinding the lifeline 120 from the rotatable member).

In some examples, the crank handle 156 includes a shaft or axle 160 and a knob 162 that is rotatably coupled to the axle 160. The knob 162 may be configured to rotate about its axis of rotation 164 (shown in FIGS. 2 and 3) independent of other movement of the crank 150 and/or crank handle 156. In this manner, the knob 162 may be held in one or more orientations as the crank handle 156 is revolved around the first engaging mechanism 140 and/or second engaging mechanism 152.

The crank 150 is pivotally or hingedly coupled to the sidewall 112 such that the crank 150 is movable between a first crank position (shown in FIG. 2) and a second crank position (shown in FIG. 3). The second engaging mechanism 152 is engaged with the first engaging mechanism 140 when the crank 150 is in the first crank position. The crank 150 may be moved away from the first crank position and/or toward the second crank position to disengage the second engaging mechanism 152 from the first engaging mechanism 140. In some examples, the retractable lifeline assembly 100 includes a hinge 166 that couples the second end portion 158 of the crank 150 to an outer surface of the sidewall 112 proximate the first engaging mechanism 140.

The crank 150 may be biased away from the first crank position and/or toward the second crank position. In some examples, the retractable lifeline assembly 100 includes one or more biasing members 168 (shown in FIG. 2) that bias or urge the crank 150 away from the first crank position and/or toward the second crank position. Example biasing members 168 include, without limitation, a magnet and/or a spring. A magnet configured to attract the crank handle 156, for example, may be positioned at a location proximate the crank handle 156 when the crank 150 is in the second crank position. For another example, the hinge 166 may be coupled to a spring that biases or urges the crank 150 away from the first crank position and/or toward the second crank position. A magnet and a spring could also be used.

The retractable lifeline assembly 100 includes a housing handle 170 coupled to the housing 110. The housing handle 170 includes a grip portion 172 (e.g., a “first” grip portion) that is spaced from the housing 110. The grip portion 172 may be spaced, for example, to allow a user's hand or fingers to easily pick up and/or carry the retractable lifeline assembly 100 using the housing handle 170.

The retractable lifeline assembly 100 has a plurality of operating configurations including an unlocked configuration and a locked configuration. When the retractable lifeline assembly 100 is in the unlocked configuration, the rotatable member is allowed to freely rotate in a plurality of directions. For example, the rotatable member may be selectively rotated in the first direction (e.g., for retracting or winding the lifeline 120 around the rotatable member) or in the second direction (e.g., for paying out or unwinding the lifeline 120 from the rotatable member) when the retractable lifeline assembly 100 is in the unlocked configuration. On the other hand, when the retractable lifeline assembly 100 is in the locked configuration, the rotatable member may be restricted from rotating in one or more directions. For example, the rotatable member may be rotatable in only a single direction (e.g., for winding the lifeline 120 around the rotatable member or unwinding the lifeline 120 from the rotatable member, but not both) when the retractable lifeline assembly 100 is in the locked configuration. Preferably, the rotatable member is restricted from rotating to unwind the lifeline from the rotatable member.

In some examples, the retractable lifeline assembly 100 includes a release mechanism 180 (shown in FIG. 1) that is actuatable to move the retractable lifeline assembly 100 between the locked configuration and the unlocked configuration. The release mechanism 180 may be moved, for example, between a first position, in which the retractable lifeline assembly 100 is in the locked configuration, and a second position, in which the retractable lifeline assembly 100 is in the unlocked configuration. The release mechanism 180 may be biased toward the first position or away from the second position, and/or away from the first position or toward the second position. Preferably, the release mechanism 180 is biased in the locked configuration.

The release mechanism 180 may extend and/or be positioned between the housing handle 170 and the housing 110 to allow a user's hand or fingers to easily access the release mechanism 180 (e.g., for actuating the release mechanism 180) while using the housing handle 170. In some examples, the release mechanism 180 includes a grip portion 182 (e.g., a “second” grip portion, shown in FIG. 1) between the first grip portion 172 and the housing 110. The second grip portion 182 may extend, for example, generally parallel to the first grip portion 172 and/or within finger's reach (e.g., while using the housing handle 170).

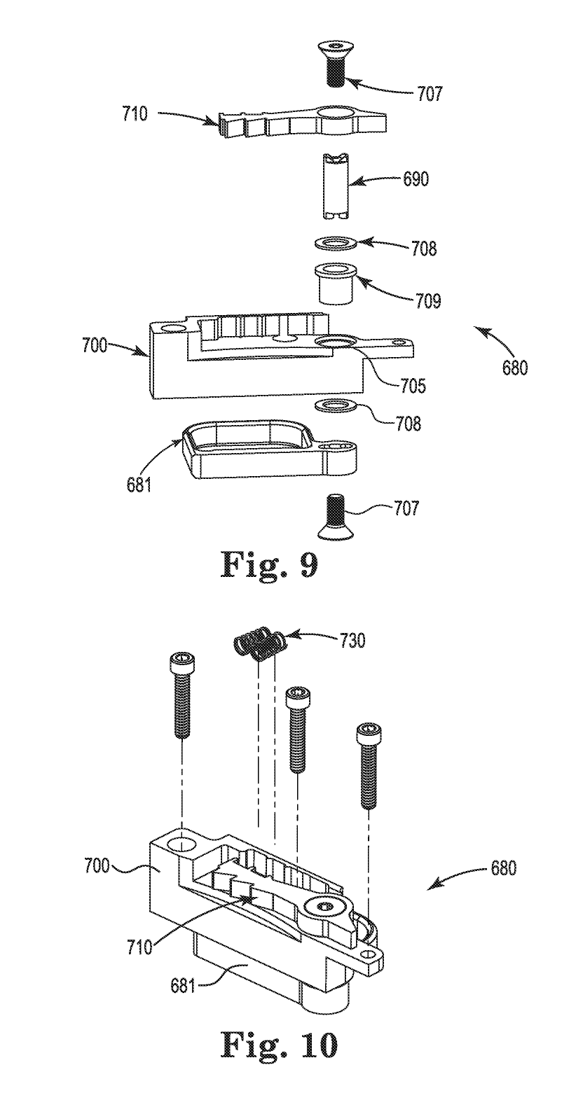

FIGS. 5-13B show a plurality of components 600 that may be used in a retractable lifeline assembly 100′. The components 600 include a rotatable member 630 (e.g., a drum), a lifeline 620 extendable about the rotatable member 630, a pawl 710, and one or more gear(s) 720 that may be used to couple the rotatable member 630 to a first engaging mechanism 140′. A gear 720 may include, for example, a plurality of teeth 722 that are configured to cooperate with and/or engage the pawl 710.

The pawl 710 is positionable to engage one or more teeth 722. The pawl 710 may be moved, for example, between a first position 711 and a second position 712. The pawl 710 is positioned to engage with one or more teeth 722 when in the first position 711. The pawl 710 may be moved away from the first position 711 and/or toward the second position 712 to disengage from the teeth 722. The retractable lifeline assembly 100′ may include a biasing member 730 (e.g., a torsion spring, a leaf spring, or any other suitable biasing member) that biases or urges the pawl 710 toward the first position 711 and/or away from the second position 712. In some examples, the retractable lifeline assembly 100 is in a locked configuration when the pawl 710 is in the first position 711, and in an unlocked configuration when the pawl 710 is in the second position 712. Preferably, the retractable lifeline assembly 100 is biased in a locked configuration.

The gear 720 may be rotated in a first direction when the pawl 710 is in the first position 711. As a rotational force is applied to the gear 720 in the first direction (e.g., by rotating the rotatable member 630 and/or first engaging mechanism 140′), each tooth 722 successively engages the pawl 710 to move the pawl 710 away from the first position 711 and toward the second position 712 until the pawl 710 is cleared, when the next tooth 722 is positioned to engage the pawl 710. Each tooth 722 may have, for example, a moderate slope on a first edge that allows the pawl 710 to slide or move up the first edge as the gear 720 is rotated in the first direction. When the tip of the tooth 722 is moved past the pawl 710, the pawl 710 moves back toward the first position 711 such that the pawl 710 is positioned to engage the next tooth 722.

On the other hand, the gear 720 may be restricted from rotating in a second direction when the pawl 710 is in the first position 711. When a rotational force is applied to the gear 720 in the second direction (e.g., via the rotatable member 630 and/or first engaging mechanism 140′) while the pawl 710 is in the first position 711, the pawl 710 acts as a mechanical stop and restricts the gear 720 from rotating. Each tooth 722 may have, for example, a steeper slope on a second edge that restricts the pawl 710 from moving up the second edge.

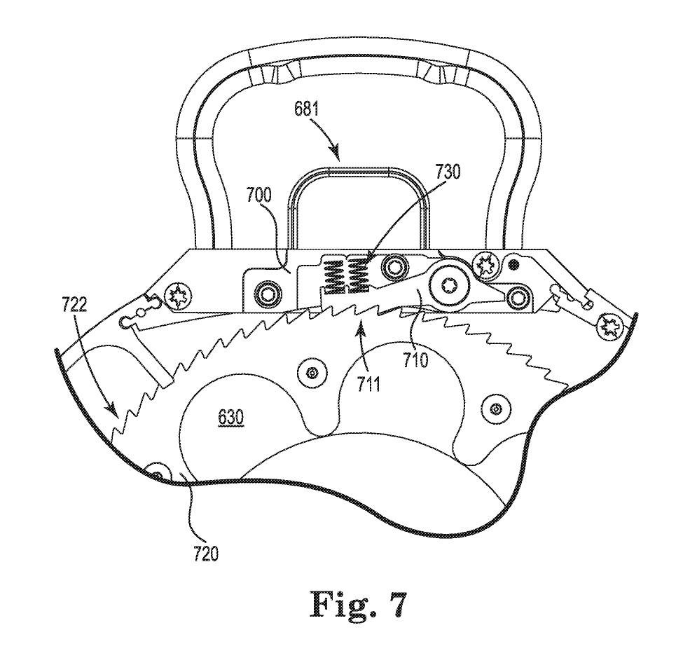

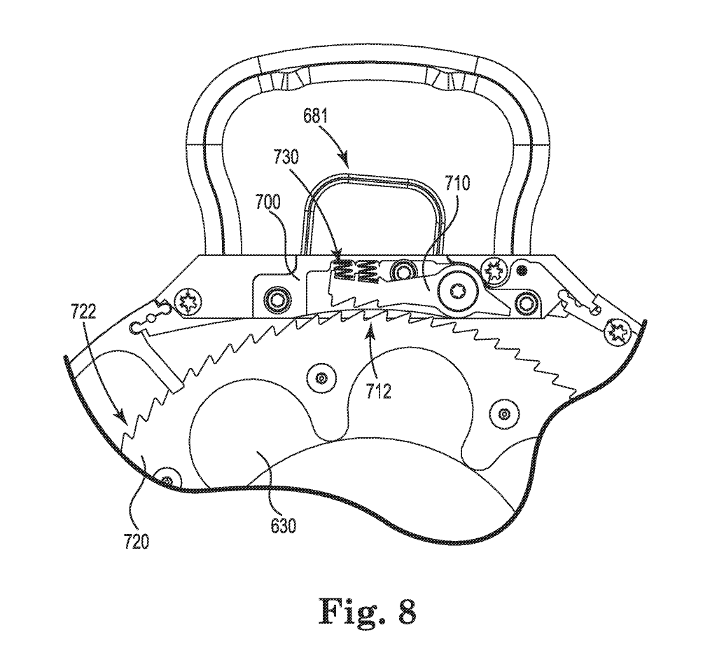

In some examples, the pawl 710 is movable using the release mechanism 680. As illustrated in FIGS. 7-8, the release mechanism 680 may be actuated to move the pawl 710, for example, toward the second position 712. When the pawl 710 is in the second position 712, the gear 720 may be selectively rotated in either the first direction or the second direction.

An example release mechanism 680 includes a handle 681 operatively connected to the pawl 710 and pivotable relative to a cartridge 700 connected to the housing. The cartridge 700 receives the pawl 710 in a first cavity on one side and receives a portion of the handle 681 in a second cavity on an opposing side. The cartridge 700 includes a bore 705 through which a connecting member 690 extends. A bushing 709 could be positioned between the bore 705 and the connecting member 690 and washers 708 could be positioned about first and second ends 691 and 692 of the connecting member 690 to assist in rotation of the connecting member 690 within the bore 705. The first end 691 includes an extension 691a, the second end 692 includes an extension 692a, and a bore 693 extends longitudinally through the connecting member 690. Proximate the first and second ends 691 and 692 the bore 693 is preferably threaded.

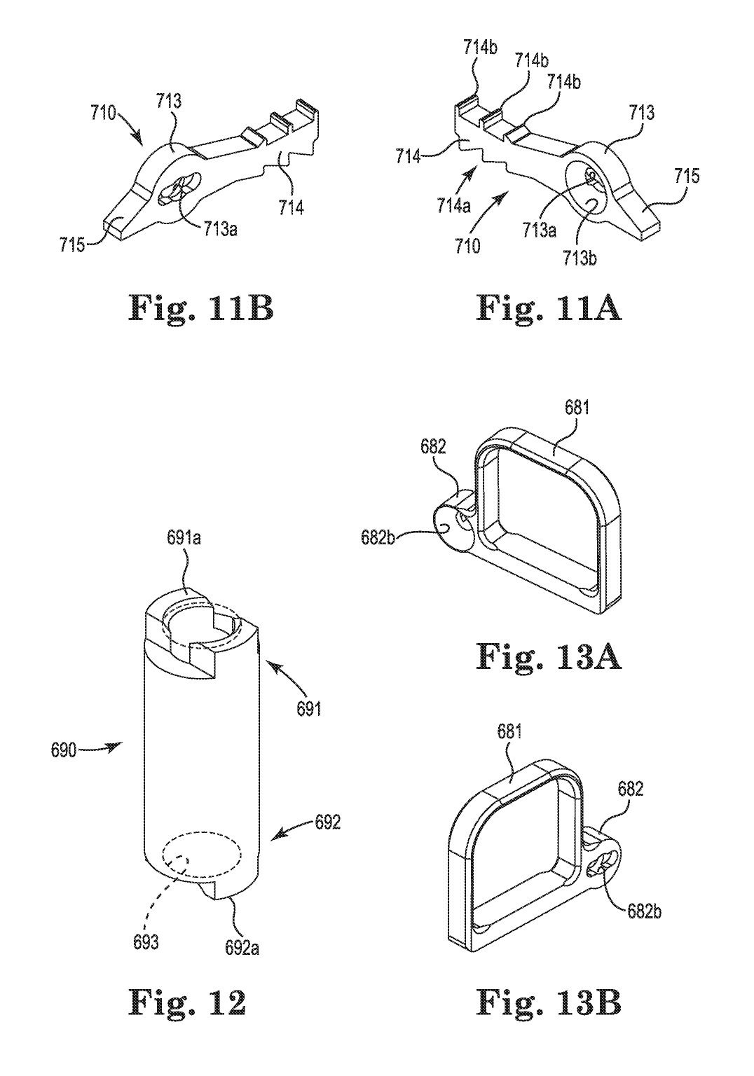

The first end 691 is operatively connected to the pawl 710. As illustrated in FIGS. 11A and 11B, an example pawl 710 includes a pivot portion 713 having a plate portion with an aperture 713a proximate one side and a bore 713b proximate an opposing side, the aperture 713a and the bore 713b being in fluid communication. An engaging portion 714 extends outward from one side of the pivot portion 713 and a stop portion 715 extends outward from an opposing side of the pivot portion 713. The engaging portion 714 includes at least one tooth 714a configured and arranged to engage at least one tooth 722 of the gear 720 proximate the bottom of the pawl 710 and extensions 714b extending outward proximate the top of the pawl 710. The extension 691a of the connecting member 690 extends through the aperture 713a, and they are configured such that the extension 691a cannot rotate within the aperture 713a. A fastener 707 is inserted through the bore 713b of the pivot portion 713 and into the bore 693 of the connecting member 690 to fasten the pawl 710 to the connecting member 690. Preferably, the fastener 707 is threaded to mate with the threads of the bore 693.

The second end 692 is operatively connected to the handle 681. As illustrated in FIGS. 13A and 13B, an example handle 681 may be generally D-shaped and include a pivot portion 682 extending outward from proximate a bottom corner. The pivot portion 682 includes a plate portion with an aperture 682a proximate one side and a bore 682b proximate an opposing side, the aperture 682a and the bore 682b being in fluid communication. The extension 692a of the connecting member 690 extends through the aperture 682a, and they are configured such that the extension 692a cannot rotate within the aperture 682a. A fastener 707 is inserted through the bore 682b of the pivot portion 682 and into the bore 693 of the connecting member 690 to fasten the handle 681 to the connecting member 690. Preferably, the fastener 707 is threaded to mate with the threads of the bore 693. A bottom portion of the handle 681 is positioned within the housing, the sides extend through the housing, and an upper, grasping portion is positioned outside of the housing.

With the pawl 710 and the handle 681 connected to the connecting member 690, they are pivotable relative to the cartridge 700. When the cartridge 700 is connected to the housing, the biasing member 730 is positioned within the first cavity between the top of the cartridge 700 and the engaging portion 714 of the pawl. The extensions 714b form at least one receiving area therebetween in which the biasing member 730 is positioned. The biasing member 730 exerts force on the cartridge 700 and the pawl 710 and, because the pawl 710 is pivotable, the pawl 710 is biased or urged into the first position 711 by the biasing member 730. In this example, because the handle 681 is connected to the pawl 710, the handle 681 is also biased or urged into position by the biasing member 730.

To move the pawl 710 from the first position 711 (locked configuration) to the second position 712 (unlocked configuration), a user may pull upward on the upper, grasping portion of the handle 681 to pivot the handle 681. When the handle 681 is pulled in a direction away from the housing, the handle 681 pivots thereby pivoting the pawl 710 and compressing the biasing member 730. This is illustrated in FIG. 8. When the pawl 710 is pivoted into the second position 712, the at least one tooth 714a does not engage or come into contact with the teeth 722 of the gear 720 thereby allowing the rotatable member 630 to rotate in both the first and second directions. When the handle 681 is released by the user, the biasing member 730 biases or urges the pawl 710 and into the first position 711 thereby also moving the handle 681 in a direction toward the housing and allowing the rotatable member 630 to rotate in only the first direction.

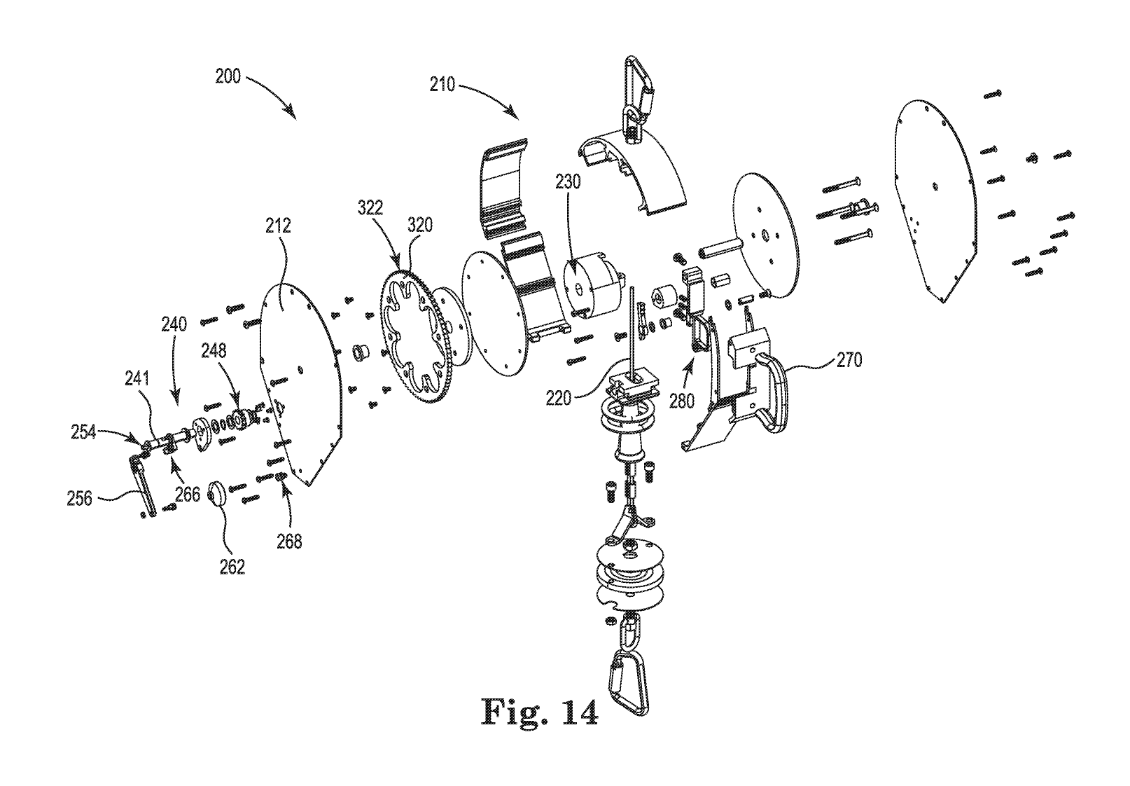

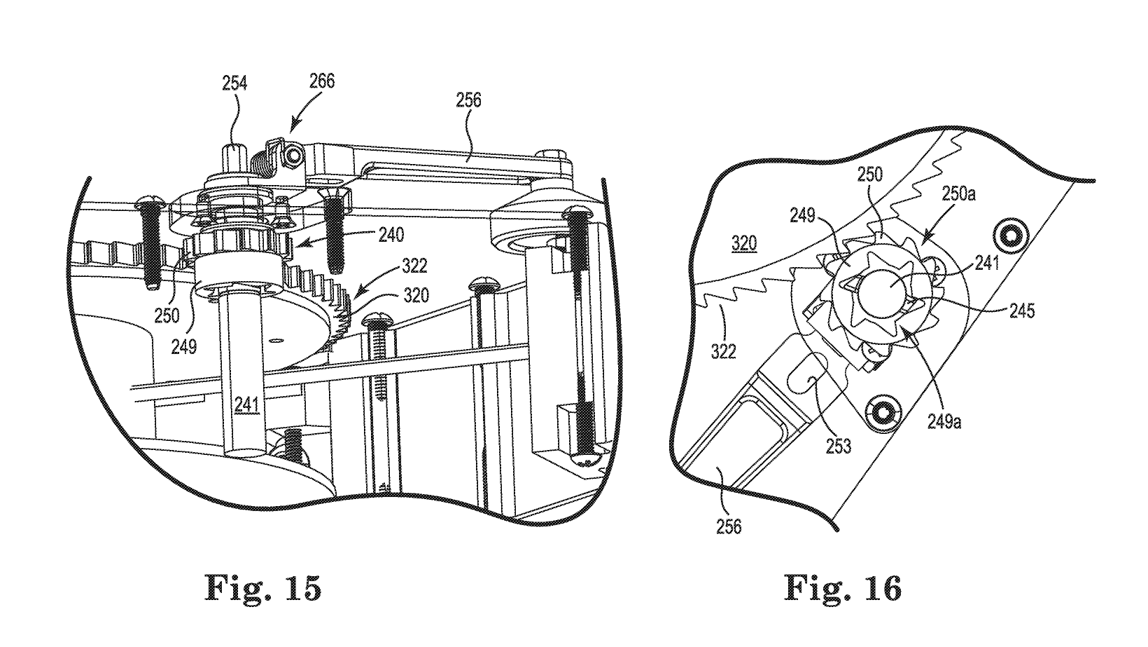

FIG. 14 shows a plurality of components that may be used in an example retractable lifeline assembly 200.

A first end of a lifeline 220 is operatively connected to a base of a rotatable member 230, which is rotatable about a shaft operatively connected to a housing 210 having at least one sidewall 212 and a handle 270. The rotatable member 230 includes a gear 320 with teeth 322. The teeth 322 may be selectively engaged by a release mechanism 280 and/or an engaging mechanism. The release mechanism 280 may be similar to the release mechanism 680.

The engaging mechanism could be one of or a combination of mechanisms. For example, a first engaging mechanism 240 includes a shaft 241 to which an engaging assembly 248 is operatively connected. For example, the engaging assembly 248 could include a bore 248a through which the shaft 241 extends. The engaging assembly 248 includes a flange 250 forming teeth 250a about its periphery, and the teeth 250a are configured and arranged to engage the teeth 322 operatively connected to the rotatable member 230. This portion is similar to the first engaging mechanisms 140 and 140′.

Optionally, the first engaging mechanism 240 could include a one-way bearing such that rotation of the shaft 241 in a first direction rotates the engaging assembly 248 but rotation of the shaft 241 in an opposite second direction does not rotate the engaging assembly 248. This assists in keeping the engaging assembly 248 and thereby the rotatable member 230 from rotating in a direction to pay out the lifeline 220 and keep tension on the lifeline 220.

For a one-way bearing, the engaging assembly 248 could optionally include a base 249 extending longitudinally from the flange 250, the base 249 forming teeth 249a extending into the bore 248a. The shaft 241 could include a bore 242 configured and arranged to receive at least one pawl 243 to selectively engage at least one tooth of teeth 249a.

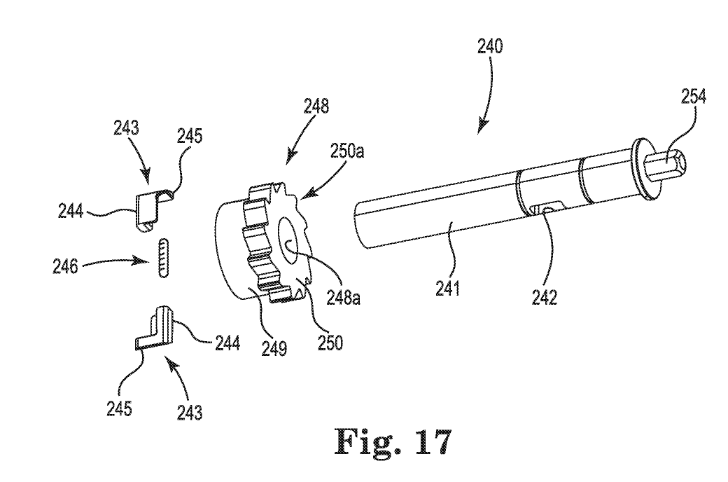

In one example, shown in FIG. 17, there are two pawls 243, and each pawl 243 is generally L-shaped and includes a receiving portion 244 configured and arranged to receive a portion of biasing member 246 and an engaging portion 245. The biasing member 246 is positioned within the receiving portions 244 to interconnect the two pawls 243 and places a biasing force on the pawls 243 to bias them away from each other so that the engaging portions 245 extend outward from the bore 242. The shaft 241 is inserted through the bore 248a so that the bore 242 and the pawls 243 are positioned within the base 249 portion of the engaging assembly 248. The pawls 243 are biased outwardly to selectively engage teeth 250a. Because of the geometry of the teeth 249a and the pawls 243, the pawls 243 engage the teeth 249a in one direction but not in an opposite direction. This is illustrated in FIG. 16. In one direction, the pawls 243 contact stopping surfaces of the teeth 249a and rotation of the shaft 241 rotates the engaging assembly 248. In the opposite direction, angled portions of the pawls 243 slide along angled surfaces of the teeth 249a during rotation, which compresses the biasing member 246 and moves the pawls 243 inward within the bore 242 to move past the tooth. When the pawls 243 are positioned between the respective stopping surfaces and angled surfaces, the biasing member 246 will bias the pawls outward. In this opposite direction, the pawls 243 will not engage the teeth 249a and rotation of the shaft 241 will not rotate the engaging assembly 248.

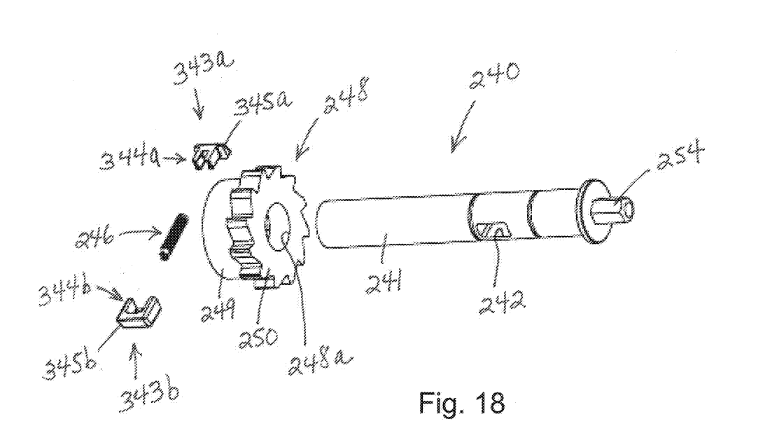

The pawls 243 could be substituted with any other suitable engaging member. For example, the pawls 243 could be substituted with pawls 343a and 343b, shown in FIG. 18. The pawl 343a includes a receiving portion 344a configured and arranged to receive a portion of biasing member 246 and an engaging portion 345a from which the receiving portion 344a extends. The pawl 343b includes a receiving portion 344b configured and arranged to receive portions of the biasing member 246 and the receiving portion 344a and an engaging portion 345b from which the receiving portion 344b extends. The pawls 343a and 343b slide relative to one another, with the biasing member 246 biasing them away from one another, and the receiving portions 344a and 344b assist in keeping them aligned. The pawls 343a and 343b operate similarly with the first engaging mechanism as pawls 243.

A second engaging mechanism 252 includes a shaft 254 extending from the shaft 241 of the first engaging mechanism 240. The shaft 254 has a shape (e.g., square, hexagonal, triangular, opposing flat surfaces) to assist in being inserted through an opening 253 in the crank handle 256 and being engaged by the crank handle 256. When the crank handle 256 is pivoted about hinge 266 from a storage position into a use position, the shaft 254 extends through the opening 253, and when the crank handle 256 is rotated (e.g., via knob 262), the shaft 254 rotates. In the storage position, a biasing member 268 could be used to bias the crank handle 256 into this position. The biasing member 268 which could be at least one of a magnet, a spring, or the like.

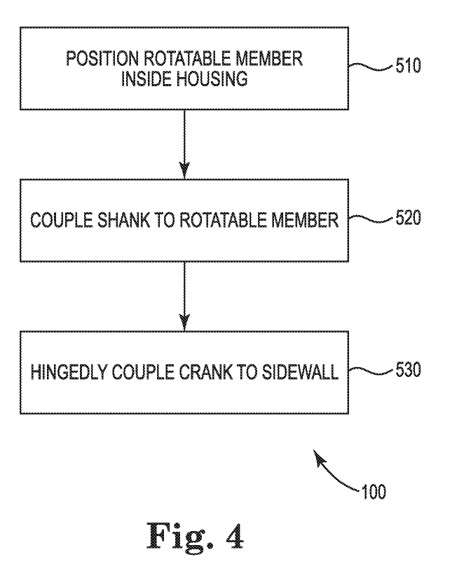

FIG. 4 shows an example method 500 of manufacturing a retractable lifeline assembly. A plurality of components may be positioned inside a housing. For example, a lifeline, a rotatable member, a pawl, and/or a gear are positioned inside the housing at operation 510. A first segment of the lifeline may be wound around the rotatable member, and a second segment of the lifeline may be extended from the rotatable member and outside the housing (e.g., beyond the sidewalls). The pawl may be coupled to the rotatable member such that the pawl is selectively positionable to engage the teeth of the gear. In some examples, the pawl is positioned to engage at least one tooth when in a first position, and disengage from the teeth when in a second position.

A first engaging mechanism may be coupled to the rotatable member for rotating the rotatable member. For example, the first engaging mechanism is coupled to the rotatable member at operation 520. The first engaging mechanism may be coupled to the rotatable member using one or more gear(s) having a gear ratio that enables a mechanical advantage to be created when the first engaging mechanism is rotated (e.g., for rotating the rotatable member). In some examples, the first engaging mechanism extends outward from and generally perpendicular to an outer surface of a sidewall (e.g., to allow a clamp or chuck to hold the first engaging mechanism).

A crank is pivotally or hingedly coupled to the sidewall at operation 530. The crank includes a second engaging mechanism that is selectively engaged with the first engaging mechanism. In some examples, the crank is selectively movable between an engaged position (e.g., a first crank position), in which the second engaging mechanism is engaged with the first engaging mechanism, and a disengaged position (e.g., a second crank position), in which the second engaging mechanism is disengaged from the first engaging mechanism. When the crank is in the engaged position, the crank may be used to rotate the first engaging mechanism (e.g., for extending the lifeline from and/or retracting the lifeline into the housing).

In some example methods, a housing handle and a release mechanism are coupled to the housing. The housing handle may include a grip portion that is spaced from the housing, and the release mechanism may include a grip portion that is between the grip portion and the housing. The release mechanism may be actuated to move the retractable lifeline assembly between an unlocked configuration, in which the rotatable member is allowed to rotate in a plurality of directions, and a locked configuration, in which the rotatable member is restricted from rotating in at least one direction.

To install a retractable lifeline assembly to suitable anchorage connectors, the distal end of the lifeline is attached to one anchorage connector with a suitable connector such as a shackle or a carabiner. Optionally, an energy absorber interconnects the lifeline and the connector. The housing is then carried by the carrying handle while engaging the spool release trigger so that the lifeline is paid out as the housing is carried to the second anchorage connector. The housing (e.g., a swivel connector of the housing) is connected to the second anchorage connector with a suitable connector such as a shackle or a carabiner. The lifeline is then tensioned by first pivoting the crank handle to engage the shaft of the tensioning mechanism (e.g., the second engaging member). Then, the crank handle is rotated until properly tensioned. The tensioning may be done manually or with a drill. A user may connect to an O-ring on the lifeline or directly to the lifeline.

To release tension on the lifeline and/or uninstall the retractable lifeline assembly, the crank handle is rotated a partial turn to transition tension away from the release mechanism, and then the handle of the release mechanism is positioned to release the rotatable member. The lifeline may be paid out sufficiently to allow for removal from the anchorage connector.

Example safety equipment are described herein and illustrated in the accompanying drawings. The examples described herein provide a retractable lifeline assembly including a crank that is securely coupled and optionally engaged. The crank may be used to selectively adjust (e.g., extend, retract) a lifeline. This written description uses examples to disclose aspects of the disclosure and also to enable a person skilled in the art to practice the aspects, including making or using the above-described systems and executing or performing the above-described methods.

Having described aspects of the disclosure in terms of various examples with their associated operations, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense. For example, the examples described herein may be implemented and utilized in connection with many other applications such as, but not limited to, safety equipment.

Components of the systems and/or operations of the methods described herein may be utilized independently and separately from other components and/or operations described herein. Moreover, the methods described herein may include additional or fewer operations than those disclosed, and the order of execution or performance of the operations described herein is not essential unless otherwise specified. That is, the operations may be executed or performed in any order, unless otherwise specified, and it is contemplated that executing or performing a particular operation before, contemporaneously with, or after another operation is within the scope of the disclosure. Although specific features of various examples of the disclosure may be shown in some drawings and not in others, this is for convenience only. In accordance with the principles of the disclosure, any feature of a drawing may be referenced and/or claimed in combination with any feature of any other drawing.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A retractable lifeline assembly comprising:
a housing;
a rotatable member inside the housing;
a housing handle coupled to the housing; and
a release mechanism between the housing handle and the housing, the release mechanism selectively actuatable to move the retractable lifeline assembly between an unlocked configuration in which the rotatable member is allowed to rotate in a plurality of directions and a locked configuration in which the rotatable member is restricted from rotating in at least one direction of the plurality of directions.

2. The retractable lifeline assembly of claim 1, wherein the housing handle includes a first grip portion spaced from the housing, and the release mechanism includes a second grip portion between the first grip portion and the housing.

3. The retractable lifeline assembly of claim 1 further comprising a biasing member biasing the release mechanism toward a first position, the release mechanism movable between the first position and a second position, wherein the retractable lifeline assembly is in the locked configuration when the release mechanism is in the first position and in the unlocked configuration when the release mechanism is in the second position.

4. The retractable lifeline assembly of claim 1 further comprising:
a plurality of teeth;
a pawl coupled to the rotatable member, wherein the release mechanism is configured to move the pawl for moving the retractable lifeline assembly between the unlocked configuration and the locked configuration;
a housing handle coupled to the housing; and
the release mechanism actuatable to move the pawl between the first position and the second position.

5. The retractable lifeline assembly of claim 1 further comprising:
a first engaging mechanism coupled to the rotatable member; and
a crank including a crank handle and a second engaging mechanism, the crank hingedly coupled to a sidewall of the housing such that the crank is selectively movable between a first crank position in which the second engaging mechanism is engaged with the first engaging mechanism and a second crank position in which the second engaging mechanism is disengaged from the first engaging mechanism, the crank handle selectively revolvable around the first engaging mechanism when the crank is in the first crank position for rotating the rotatable member.

6. The retractable lifeline assembly of claim 5 further comprising a biasing member biasing the crank toward the second crank position.

7. The retractable lifeline assembly of claim 5, wherein the first engaging mechanism includes a shaft, and the second engaging mechanism includes one or more walls defining an opening sized to receive the shaft.

8. The retractable lifeline assembly of claim 5, wherein the first engaging mechanism includes a pawl operatively connected to a shaft and an engaging assembly selectively engaged by the pawl, the pawl and the engaging assembly being configured and arranged to engage when the shaft is rotated a first direction thereby rotating the shaft and the engaging assembly, and the pawl and the engaging assembly being configured and arranged to disengage when the shaft is rotated in a second opposite direction thereby rotating just the shaft.

9. A retractable lifeline assembly comprising:
a housing including a sidewall;
a rotatable member inside the housing;
a first engaging mechanism coupled to the rotatable member; and
a crank including a crank handle and a second engaging mechanism, the crank pivotally coupled to the sidewall such that the crank is selectively movable between a first crank position in which the second engaging mechanism is engaged with the first engaging mechanism and a second crank position in which the second engaging mechanism is disengaged from the first engaging mechanism, the crank handle selectively engaging the first engaging mechanism when the crank is in the first crank position to rotate the rotatable member.

10. The retractable lifeline assembly of claim 9 further comprising:
a housing handle coupled to the housing; and
a release mechanism between the housing handle and the housing, the release mechanism actuatable to move the retractable lifeline assembly between a locked configuration in which the rotatable member is restricted from rotating and an unlocked configuration in which the rotatable member is allowed to rotate.

11. The retractable lifeline assembly of claim 9 further comprising:
a housing handle coupled to the housing, the housing handle including a first grip portion spaced from the housing; and
a release mechanism including a second grip portion between the first grip portion and the housing, the release mechanism actuatable to move the retractable lifeline assembly between a locked configuration in which the rotatable member is restricted from rotating and an unlocked configuration in which the rotatable member is allowed to rotate. The retractable lifeline assembly of claim 9 further comprising:
a housing handle coupled to the housing;
a release mechanism between the housing handle and the housing, the release mechanism movable between a first position and a second position, wherein the retractable lifeline assembly is in a locked configuration when the release mechanism is in the first position and in an unlocked configuration when the release mechanism is in the second position; and
a biasing member biasing the release mechanism toward the first position.

12. The retractable lifeline assembly of claim 9 further comprising:
a plurality of teeth;
a pawl coupled to the rotatable member, the pawl movable between a first position in which the pawl is engaged with at least one tooth of the plurality of teeth and a second position in which the pawl is disengaged from the plurality of teeth;
a housing handle coupled to the housing; and
a release mechanism between the housing handle and the housing, the release mechanism actuatable to move the pawl between the first position and the second position.

13. The retractable lifeline assembly of claim 9 further comprising a biasing member biasing the crank toward the second crank position.

14. The retractable lifeline assembly of claim 9, wherein the first engaging mechanism includes a shaft, and the second engaging mechanism includes one or more walls defining an opening sized to receive the shaft.

15. The retractable lifeline assembly of claim 9, wherein the first engaging mechanism includes a pawl operatively connected to a shaft and an engaging assembly selectively engaged by the pawl, the pawl and the engaging assembly being configured and arranged to engage when the shaft is rotated a first direction thereby rotating the shaft and the engaging assembly, and the pawl and the engaging assembly being configured and arranged to disengage when the shaft is rotated in a second opposite direction thereby rotating just the shaft.

16. A method of manufacturing a retractable lifeline assembly, the method comprising:
positioning a rotatable member inside a housing, the housing including a sidewall;
coupling a first engaging mechanism to the rotatable member; and hingedly coupling a crank to the sidewall such that the crank is selectively movable between an engaged position and a disengaged position, the crank including a second engaging mechanism that is engaged with the first engaging mechanism when the crank is in the engaged position and disengaged from the first engaging mechanism when the crank is in the disengaged position, the crank further including a crank handle that is selectively revolvable about the first engaging mechanism when the crank is in the engaged position to rotate the rotatable member.

17. The method of claim 17 further comprising:
coupling a housing handle to the housing; and
positioning a release mechanism between the housing handle and the housing, the release mechanism actuatable to move the retractable lifeline assembly between an unlocked configuration in which the rotatable member is allowed to rotate in a plurality of directions and a locked configuration in which the rotatable member is restricted from rotating in at least one direction of the plurality of directions.

18. The method of claim 17 further comprising:
coupling a housing handle to the housing;
positioning a release mechanism between the housing handle and the housing, the release mechanism movable between a first position and a second position, wherein the retractable lifeline assembly is in a locked configuration when the release mechanism is in the first position and in an unlocked configuration when the release mechanism is in the second position; and
positioning a biasing member to bias the release mechanism toward the first position.

19. The method of claim 17 further comprising positioning a biasing member to bias the crank toward the second crank position.
